(19) United States
(12) Patent Application Publication
(10) Pub. No.: US 2013/0152011 A1
(43) Pub. Date: Jun. 13, 2013

(54) SYSTEM AND METHOD FOR NAVIGATING IN AN ELECTRONIC PUBLICATION

(71) Applicant: barnesandnoble.com llc, New York, NY (US)

(72) Inventors: Matthew PALLAKOFF, Mountain View, CA (US); Harold Edward COHN, Incline Village, NV (US)

(73) Assignee: BARNESANDNOBLE.COM LLC, New York, NY (US)

(21) Appl. No.: 13/712,313

(22) Filed: Dec. 12, 2012

Related U.S. Application Data
(60) Provisional application No. 61/569,681, filed on Dec. 12, 2011.

(51) Int. Cl. G06F 3/0488

(52) U.S. Cl. CPC G06F 3/0488
USPC 715/784

(57) ABSTRACT

A system and method for navigating electronic using controls on a touch screen of a reading device. The controls allow the user to quickly skim, scan, and scroll through all the sections of the publication with short slides of a thumb or finger. The controls preferably take the form of a strip displayed along an edge, e.g., the bottom, of the touch screen device used for reading the publication. A second control can be formed along another edge of the touch screen, e.g., right or left edge, to enable the user to rapidly skim through all of the articles contained in a selected section.

### FIELD OF THE INVENTION

The present invention generally relates to devices for reading digital content, and more particularly to systems and methods for navigating the content in an electronic publication.

### BACKGROUND OF THE INVENTION

Electronic devices such as cellular phones, eReaders, and tablets are fast becoming necessities, especially for people on the move. Electronic devices can be used to place phone calls, to text messages, read electronic publications to browse the Internet, to take pictures and the like. The display area on a mobile electronic device can be limited due to its size, but the display area is usually adequate for viewing pictures or displaying text. Electronic devices typically include means for scrolling through text, such as pressing keys located on the device's keypad, a tracking wheel or other buttons located on the device.

The increasing popularity of touch screen devices with multitouch capabilities have alleviated, to some extent, the difficulties in navigating through digital publications. However the screen size of these mobile devices and the formatting of the electronic publications still present a limitation on the ease with which one can navigate a digital publication. Improved systems and methods for navigating electronic documents using an electronic device would be desirable.

### SUMMARY OF THE INVENTION

The system and method of the present invention provide a reader of an electronic publication with controls on a touch screen of the reading device. The controls allow the user to quickly skim, scan, and scroll through all the sections of the publication with short slides of a thumb or finger. The controls preferably take the form of a strip displayed along an edge, e.g., the bottom, of the touch screen device used for reading the publication. In a preferred embodiment, a second control, formed along another edge of the touch screen, e.g., right or left edge, allows the user to rapidly skim through all of the articles contained in a selected section.

### BRIEF DESCRIPTION OF THE DRAWINGS

For the purposes of illustrating the present invention, there is shown in the drawings a form which is presently preferred, it being understood however, that the invention is not limited to the precise form shown by the drawing in which:

FIG. 1 illustrates a User Interface of an electronic newspaper with a section control at the bottom of the display screen;

FIG. 2 illustrates the section control expanded to reveal the sections of the electronic publication and the section control;

FIG. 3 illustrates a user selecting a section from the section control;

FIG. 4 depicts an article in the selected section with the article control along the right edge of the touch screen;

FIG. 5 illustrates the article control expanded to display a list of the articles in the section;

FIG. 6 illustrates an exemplary system according to the present invention; and

FIG. 7 illustrates the components of an exemplary device.

### DETAILED DESCRIPTION OF THE INVENTION

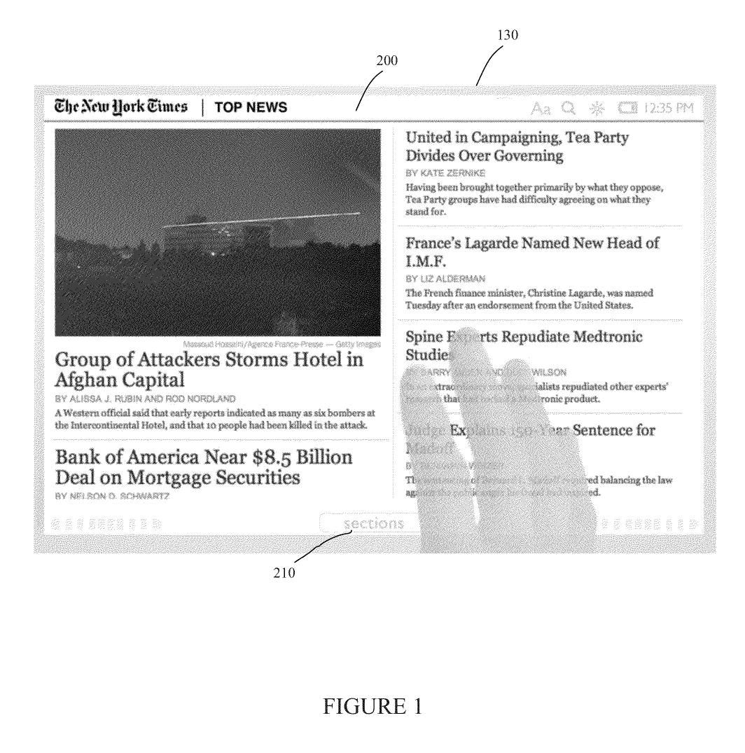

FIG. 1 illustrates a User Interface 200 of reading device 130 displaying an electronic publication. In the particular example used throughout the present disclosure, the electronic publication is an electronic newspaper. However, as appreciated by those skilled in the art, the present invention is not limited to electronic newspapers, but is particularly adapted to any electronic publication that is logically divided into sections and preferably each section being further divided into subsections, such as articles.

At the bottom of the screen 200 on device 130 a section control button 210 of the present invention is displayed. In order to expand the section control button 210 to more fully view the sections in the electronic publication the user taps the section control button 210. As described herein, the device 130 preferably includes a touch screen which the user can tap to make selections or swipe to scroll. As appreciated by those skilled in the art, though, other user control mechanisms can be used with the present invention, such as a trackpad.

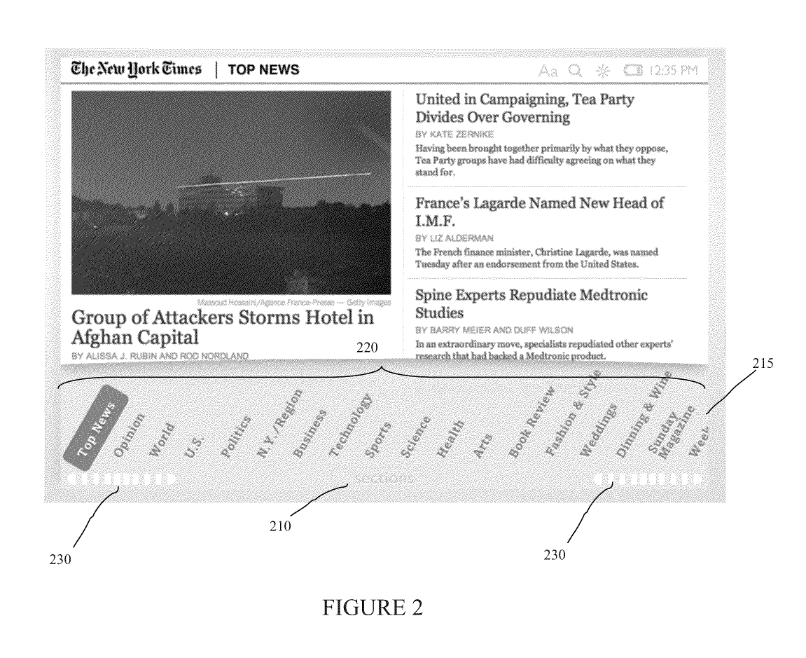

FIG. 2 illustrates the section control are 215 expanded to reveal a plurality of the sections 220 of the electronic publication and the section controls 230. The term “skimmer” will occasionally be used to describe the section control area 21 and section control strips 230 as it allows the user to quickly skim through the sections of the electronic document.

The present invention provides a reader of an electronic publication, preferably an electronic periodical such as a newspaper or magazine, to skim through all of the sections 220 of the publication with short slides of a thumb, or finger along a strip 230. In a preferred embodiment the section control area 215 and the strip 230 are displayed along an edge, e.g., the bottom, of the touch screen of the device 130 used for reading the publication. Employing the skimmer strip 230, a user can skim through a fairly long list of items or screens with just one or a few short, effortless slides near the edge of screen of the device 130.

A short slide on skim strip 230 moves the displayed list 220 many items and a long distance, across the screen. For example, a one inch slide on skimmer 230 might move the displayed marker 3 inches, and move it across, say, 10 items. In effect, the present invention magnifies the user's motion, which minimizes their effort. Given the relatively small size of the screen on a typical mobile device 130, such as a mobile phone or a tablet, this feature of the skimmer 230 enables quick navigation through long menus or lists.

In preferred embodiments, the movement of the displayed marker (which is often called the “focus”) will be accompanied by a change in corresponding content that is displayed on the main section of the screen of device 130 above or to the side of the skimmer 230. For example, in the skimmer-enhanced newspaper user interface illustrated in FIG. 2, as the user skims across the newspaper section titles using the skimmer 230 at the bottom of the page, the entire page of content above the section control area 215 can very rapidly update to reflect whichever section title is in focus. The effect is somewhat like flipping very quickly through a traditional hardcopy magazine.

The mechanism of the skimmer 230 can be applied to other areas. For example, “skimming” through the speech bubbles on a comic book page. Each bubble can be zoomed, one by one, so a user can read the text in each bubble in sequence as she slides her thumb on the skimmer strip. The skimmer 230 can also be applied to long lists of items such as menus that have more items than can fit on one screen, such as shop categories in a shopping application.

There are different ways to animate the list of items 220 as it auto-scrolls when the user's finger reaches the end of the visible items, so that the user stays oriented and understands what's happening.

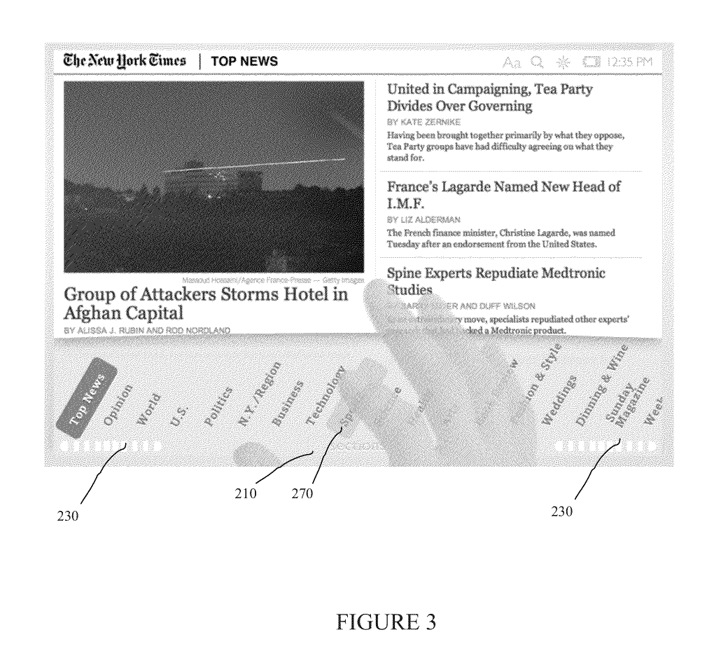

As shown in FIG. 3, the system displays s list of sections 220 in the section control 210 area. If the user does not want to make a selection of any of the sections 220 and wants to collapse the expanded section control 215 area, she could tap the sections button 210 again, or swipe down within any part of the section list 220 In some embodiments the user could tap any area of the screen outside of the section list 220 or in a subset of the area designated by the designer for tapping out of the section list. In the newspaper example illustrated in FIG. 3, the option of closing out the section control area 210 by tapping in the content is not as desirable as almost anywhere the user taps on the content portion of the screen will be an active link to a an article. However, the present invention is flexible and agnostic about how an system designer can allow the user to close the skimmer section control area 215.

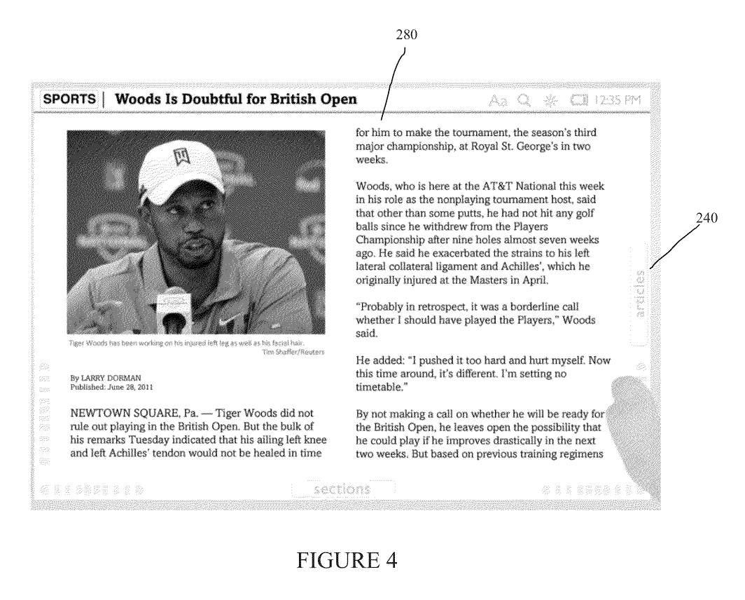

In the embodiment illustrated in FIG. 3, the user is selecting the Sports section 270 from the list 220 of sections in the section control area 215. This selection of the Sports section results in a display of several article summaries from the Sports section 270 of the periodical. The format of the Sports section 270 screen would be similar to the format of the TOP NEWS section screen illustrated in FIGS. 1-3. This preferred formatting shows the headlines, photos, and summaries corresponding to various articles in that section. The user may tap an article headline, photo, or article summary to open an article. For example, as illustrated in FIG. 4, the user tapped on a headline about an article about Tiger Woods and caused the display of the corresponding article 280.

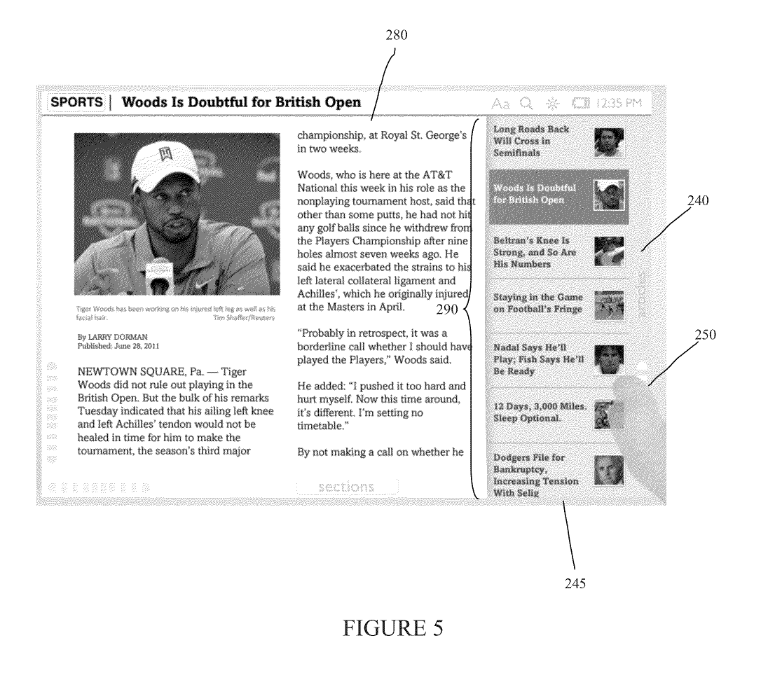

As shown in FIG. 4, in addition to displaying an article 280 within a given section, an embodiment of the present invention displays an article control button 240 that expands a second skimmer area 245 as shown in FIG. 5. If the user selects, taps on, the article control button 240, the control area 245 is expanded to display a list of the articles 290 in the section. A skimmer strip 250, similar to the skimmer strip 230 of FIGS. 2-3, is formed along the edge of the screen, e.g., the right edge, to allow the user to skim through all of the articles 290 contained in the selected section. Similar to the Sections slider 230 as illustrated in FIG. 3, sliding a finger along the article skimmer strip 250 rapidly changes which article title is selected and also rapidly change the corresponding article 280 displayed to the left of the article skimmer area 245.

A user employs a conventional touch-screen user interface, UI, method of pressing the section 210 or article 240 buttons to expand the control areas 215, 245 and bring up the respective list of sections 220 or articles 290. The user then taps on labels representing the section or articles to display the selected section or article. Further, the user can swipe the displayed list of articles or sections in a conventional manner to see more labels contained in the list.

The user can use small slides of her finger along the strips 230, 250 on the edges of the screen to “fast skim” through the sections using one skimmer 230, or articles within a section using the other skimmer 250. These fast-skim strips 230, 250 are standalone elements used in combination with conventional touch-based list interaction methods. A user may slide a finger along a fast-skim area 230, 250 to “fly” through the sequence of items represented by that skimmer (such as a sequence of newspaper section front pages or a sequence of articles within a section). In preferred embodiments, all or most of the rest of the screen above or behind the skimmer area updates rapidly as the user flies through the sequence. For example, the system can rapidly show the front page of each successive newspaper section as the user's finger slides across the strip 230 associated with the list of sections 220. A user's eyes can pick up content and images quite quickly as each screen in the sequence briefly appears during the fast skim.

In preferred embodiments, a user may additionally do a quick fling or “flick” on a fast-skim area 230, 250, to flip from the current element of the sequence represented by that fast-skim area 230, 250 to the next or previous element of the sequence. For example flipping from the current section of a newspaper to the front of the next section of the newspaper by flicking horizontally on a fast-skim strip 230 associated with the list of sections 220. In general, a slide or fling in one direction will move one way through the sequence, while a slide or fling in the other direction will move the other way through the sequence.

In preferred embodiments, any given skimmer strip 230, 250 can be formed along any edge, either horizontally or vertically. The placement illustrated in the attached Figures is just one preferred embodiment. A benefit to placing skimmer strips along display edges is that the user can easily find those positions with her fingers, by feeling a bevel edge or by knowing the strip is a short distance in from the device edge. Alternative embodiments of the present invention support fast-skim slide gestures along other portions of the display. For example, if the user interface for a particular application or content type does not rely on a vertical (or horizontal) slide gesture for other purposes, then an embodiment can allow the user to invoke the fast-skim behavior by sliding or flinging vertically (or horizontally) anywhere on the display to invoke the fast-skim behavior. In this alternative embodiment, no controls 210, 240 and no skimmer strips 230, 250 need be displayed by the system and method employing the present invention.

Some content and or applications only need one skimmer, or two strips that skim the same labels. For example, a publication that had a couple dozen articles but no “sections” (like a journal) might use have one article skimmer 250. Alternatively, one article skimmer strip can be formed along the left edge and another skimmer strip along the right edge, both of which do the same thing. This alternative embodiment accommodates use by either a left or right handed user.

Other applications, like the digital newspaper viewer embodiment illustrated in the Figures of the present application, benefit from two different skimmers 230, 250. One skimmer 230 is used for skimming sections 220 and the other skimmer 250 is used for skimming articles 290 within a given section. In an alternative embodiment, one or two strips work for one set of items, e.g., two article skimmers, one on the left edge and one on the right, and one or two strips work for another set of items. For example, a single long section-skimming strip along the bottom edge.

It is useful to preserve the ability to open a list with a click on a button, such as the “sections” button 210 used in these illustrations, and then tap items in the list, and drag/scroll/fling/swipe the list. These conventional methods can be supported in addition to the fast-skimming strips as an additional way to interact with the lists.

As appreciated by those skilled in the art, the skimmer mechanism of the present invention can apply to many applications, not just electronic readers. For example a skimmer can be used to select applications, photo/media, music, preferences or games. A device 130 can have more then one or two skimmer regions and they do not have to be placed against the edges of the screen. Skimmers can be invisible or explicitly visible regions. Skimmer content itself can be scrolled, i.e., items within the skimmer can extend beyond what is shown on the screen. When a user moves to one side or the other of the skimmer, items within it can be scrolled in and out to show the user more content.

Skimmers may or may not contain content themselves. They may simply be regions that affect screen contents. Skimmers may or may not affect the screen content in real-time as a user employs the skim functionality. It may update the screen live, or may update in a delayed fashion. The size and shape of the skimmer, in proportion to the device touch pad, can be varied.

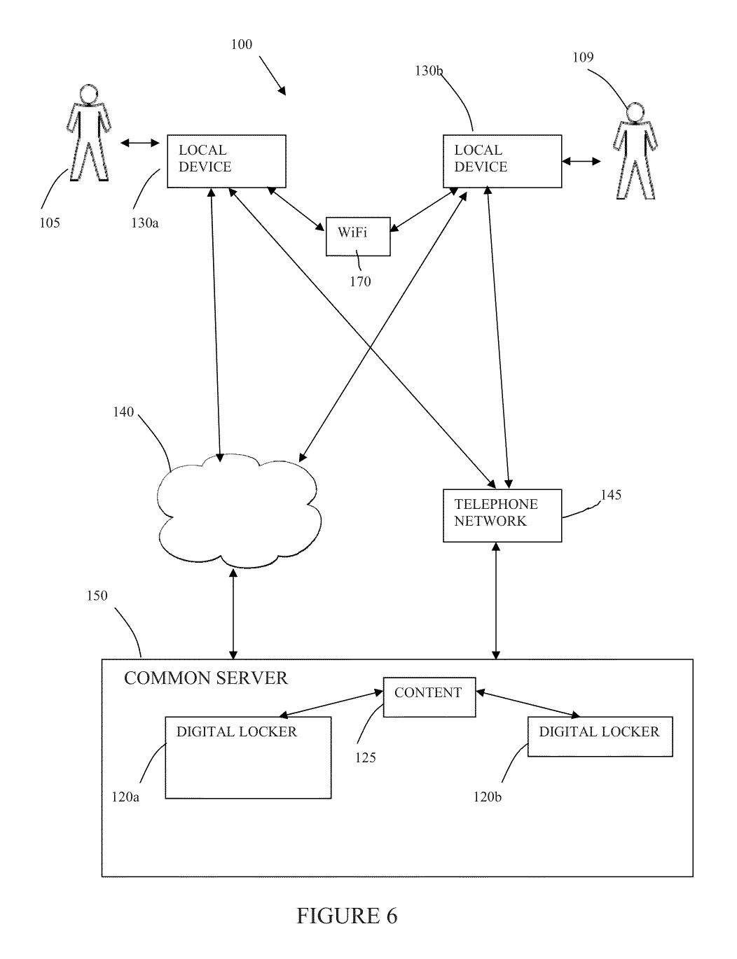

FIG. 6 shows components of an embodiment of a system according to the present invention. First user 105 is an authorized user of system 100 and uses her local device 130a for the reading of digital content and interacting with other users, such as a second user 109. Many of the functions of system 100 are carried out on server 150. As appreciated by those skilled in the art, many of the functions described herein can be divided between the server 150 and the users' local devices 130a, 130b. Further, as also appreciated by those skilled in the art, server 150 can be considered a “cloud” with respect to the users and their local devices 130a, 130b. The cloud 150 can actually be comprised of several servers performing interconnected and distributed functions. For the sake of simplicity in the present discussion, only a single server 150 will be described. The user 105 can connect to the server 150 via the Internet 140, a telephone network 145 (e.g., wirelessly through a cellphone network) or other suitable electronic communication means. User 105 has an account on server 150, which authorizes user 105 to use system 100.

Associated with the user's 105 account is the user's digital locker 120a located on the server 150. As further described below, in the preferred embodiment of the present invention, digital locker 120a contains links to copies of digital content 125 previously purchased for otherwise legally acquired) by user 105.

Indicia of rights to all copies of digital content 125 owned by user 105, including digital content 125, is stored by reference in digital locker 120a. Digital locker 120a is a remote online repository that is uniquely associated with the user's 105 account. As appreciated by those skilled in the art, the actual copies of the digital content 125 are not necessarily stored in the user's locker 120a, but rather the locker 120a stores an indication of the rights of the user to the particular content 125 and a link or other reference to the actual digital content 125. Typically, the actual copy of the digital content 125 is stored in another mass storage (not shown). The digital lockers 120 of all of the users 105, 109 who have purchased a copy of a particular digital content 125 would point to this copy in mass storage. Of course, back up copies of all digital content 125 are maintained for disaster recovery purposes. Although only one example of digital content 125 is illustrated in this Figure, it is appreciated that the lending server 150 can contain millions of files 125 containing digital content. It is also contemplated that the server 150 can actually be comprised of several servers with access to a plurality of storage devices containing digital content 125. As further appreciated by those skilled in the art, in conventional licensing programs, the user does not own the actual copy of the digital content, but has a license to use it. Hereinafter, if reference is made to “owning” the digital content, it is understood what is meant is the license or right to use the content.

Also contained in the user's digital locker 120a is her contacts list. In a preferred embodiment, the user's contact list will also indicate if the contact is also an authorized (registered) user of the system 100 with his or her own account on server 150.

User 105 can access his or her digital locker 120a using a local device 130a. Local device 130a is an electronic device such as a personal computer, an e-book reader, a smart phone or other electronic device that the user 105 can use to access the server 150. In a preferred embodiment, the local device has been previously associated or registered, with the user's 105 account using user's 105 account credentials. Local device 130a provides the capability for user 105 to download user's 105 copy of digital content 125 via his or her digital locker 120a. After digital content 125 is downloaded to local device 130a, user 105 can engage with the downloaded content locally, e.g., read the book, listen to the music or watch the video. In the preferred embodiment, the content 125 is already divided into the logical units that can be skimmed by the skimmers of the present invention, such as sections and articles. The demarcation can occur at the publisher or distributor level, preferably at the publisher level

In a preferred embodiment, local device 130a includes a non-browser based device interface that allows user 105 to initiate the functionality of system 100 in a non-browser environment. Through the device interface, the user 105 is automatically connected to the server 150 in a non-browser based environment. This connection to the server 150 is a secure interface and can be through the telephone network 145, typically a cellular network for mobile devices. If user 105 is accessing his or her digital locker 120a using the Internet 140, local device 130a also includes a web account interface. Web account interface provides user 105 with browser-based access to his or her account and digital locker 120a over the Internet 140.

User 109 is also an authorized user of system 100. As with user 105, user 109 has an account with lending server 150, which authorizes user 109 to use lending system 100. As appreciated by those skilled in the art, the number of users 105, 109 that employ the present invention at the same time is only limited by the scalability of server 150. As with user 105, user 109 can access his or her digital locker 120b using her local device 130b. In a preferred embodiment, local device 130h is a device that user 109 has previously associated or registered, with his or her account using user's 109 account credentials. Local device 130b allows user 109 to download copies of his digital content 125 from digital locker 120b. User 109 can engage with downloaded digital content 125 locally on local device 130b.

Devices 130a and 130b can further be connected via WiFi AP 170.

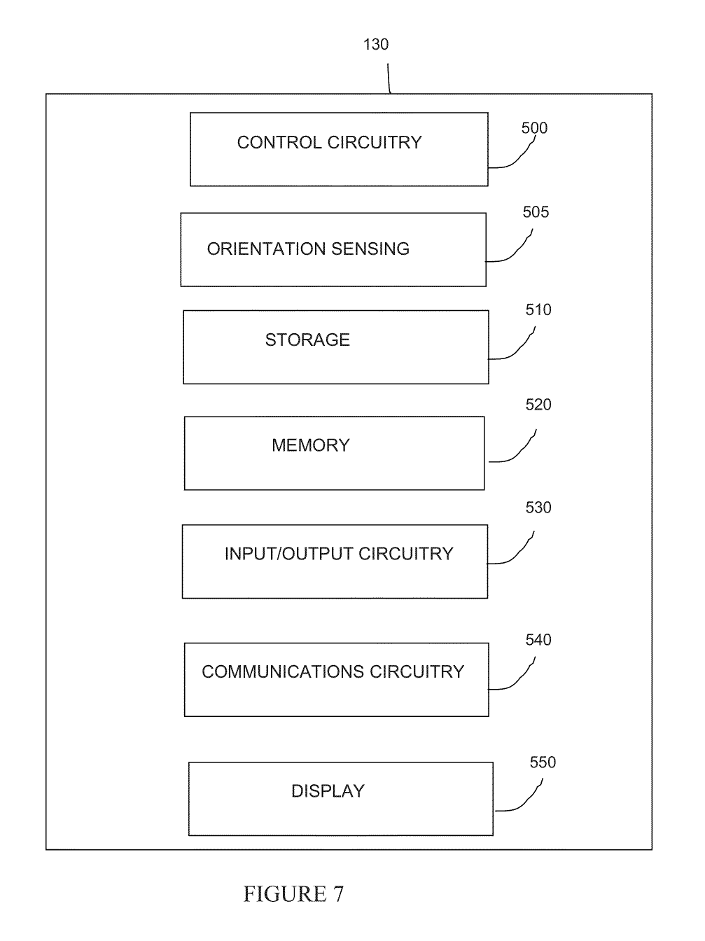

FIG. 7 illustrates an exemplary local device 130. As appreciated by those skilled the art, the local device 130 can take many forms capable of operating the present invention. As previously described, in a preferred embodiment the local device 130 is a mobile electronic device, and in an even more preferred embodiment device 130 is an electronic reader device. Electronic device 130 can include control circuitry 500, storage 510, memory 520, input/output (“I/O”) circuitry 530, communications circuitry 540, and display 550. In some embodiments, one or more of the components of electronic device 130 can be combined or omitted, storage 510 and memory 520 may be combined. As appreciated by those skilled in the art, electronic device 130 can include other components not combined or included in those shown in this Figure, a power supply such as a battery, an input mechanism, etc.

Electronic device 130 can include any suitable type of electronic device. For example, electronic device 130 can include a portable electronic device that the user may hold in his or her hand, such as a digital media player, a personal e-mail device, a personal data assistant (“PDA”), a cellular telephone, a handheld gaming device, a tablet device or an eBook reader. As another example, electronic device 130 can include a larger portable electronic device, such as a laptop computer. As yet another example, electronic device 130 can include a substantially fixed electronic device, such as a desktop computer.

Control circuitry 500 can include any processing circuitry or processor operative to control the operations and performance of electronic device 130. For example, control circuitry 500 can be used to run operating system applications, firmware applications, media playback applications, media editing applications, or any other application. Control circuitry 500 can drive the display 550 and process inputs received from a user interface, e.g., the display 550 if it is a touch screen.

Orientation sensing component 505 includes orientation hardware such as, but not limited to, an accelerometer or a gyroscopic device and the software operable to communicate the sensed orientation to the control circuitry 500. The orientation sensing component 505 is coupled to control circuitry 500 that controls the various input and output to and from the other various components. The orientation sensing component 505 is configured to sense the current orientation of the portable mobile device 130 as a whole. The orientation data is then fed to the control circuitry 500 which control an orientation sensing application. The orientation sensing application controls the graphical user interface (GUI), which drives the display 550 to present the GUI for the desired mode.

Storage 510 can include, for example, one or more computer readable storage mediums including a hard-drive, solid state drive, flash memory, permanent memory such as ROM, magnetic, optical, semiconductor, paper, or any other suitable type of storage component, or any combination thereof. Storage 510 can store, for example, media content, e.g., eBooks, music and video files, application data, e.g., software for implementing functions on electronic device 130, firmware, user preference information data, e.g., content preferences, authentication information, e.g., libraries of data associated with authorized users, transaction information data, e.g., information such as credit card information, wireless connection information data, e.g., information that can enable electronic device 130 to establish a wireless connection, subscription information data, e.g., information that keeps track of podcasts or television shows or other media a user subscribes to, contact information data, e.g., telephone numbers and email addresses, calendar information data, and any other suitable data or any combination thereof. The instructions for implementing the functions of the present invention may, as non-limiting examples, comprise software and/or scripts stored in the computer-readable media 510.

Memory 520 can include cache memory, semi-permanent memory such as RAM, and/or one or more different types of memory used for temporarily storing data. In some embodiments, memory 520 can also be used for storing data used to operate electronic device applications, or any other type of data that can be stored in storage 510. In some embodiments, memory 520 and storage 510 can be combined as a single storage medium.

I/O circuitry 530 can be operative to convert, and encode/decode, if necessary analog signals and other signals into digital data. In some embodiments, I/O circuitry 530 can also convert digital data into any other type of signal, and vice-versa. For example, I/O circuitry 530 can receive and convert physical contact inputs, e.g., from a multi-touch screen, i.e., display 550, physical movements, e.g., from a mouse or sensor, analog audio signals, e.g., from a microphone, or any other input. The digital data can be provided to and received from control circuitry 500, storage 510, and memory 520, or any other component of electronic device 130. Although I/O circuitry 530 is illustrated in this Figure as a single component of electronic device 130, several instances of I/O circuitry 530 can be included in electronic device 130.

Electronic device 130 can include any suitable interface or component for allowing a user to provide inputs to I/O circuitry 530. For example, electronic device 130 can include any suitable input mechanism, such as a button, keypad, dial, a click wheel, or a touch screen, display 550. In some embodiments, electronic device 130 can include a capacitive sensing mechanism, or a multitouch capacitive sensing mechanism.

In some embodiments, electronic device 130 can include specialized output circuitry associated with output devices such as, for example, one or more audio outputs. The audio output can include one or more speakers, e.g., mono or stereo speakers, built into electronic device 130, or an audio component that is remotely coupled to electronic device 130, e.g., a headset, headphones or earbuds that can be coupled to device 130 with a wire or wirelessly.

Display 550 includes the display and display circuitry for providing a display visible to the user. For example, the display circuitry can include a screen, e.g., an LCD screen that is incorporated in electronics device 130. In some embodiments, the display circuitry can include a coder/decoder (Codec) to convert digital media data into analog signals. For example, the display circuitry or other appropriate circuitry within electronic device can include video Codecs, audio Codecs, or any other suitable type of Codec.

The display circuitry also can include display driver circuitry, circuitry for driving display drivers, or both. The display circuitry can be operative to display content, e.g., media playback information, application screens for applications implemented on the electronic device 130, information regarding ongoing communications operations, information regarding incoming communications requests, or device operation screens, under the direction of control circuitry 500. Alternatively, the display circuitry can be operative to provide instructions to a remote display.

Communications circuitry 540 can include any suitable communications circuitry operative to connect to a communications network and to transmit communications, e.g., data from electronic device 130 to other devices within the communications network. Communications circuitry 540 can be operative to interface with the communications network using any suitable communications protocol such as, for example, Wi-Fi, e.g., a 802.11 protocol, Bluetooth, radio frequency systems, e.g., 900 MHz, 1.4 GHz, and 5.6 GHz communication systems, infrared, GSM, GSM plus EDGE, CDMA, quadband, and other cellular protocols, VOIP, or any other suitable protocol.

Electronic device 130 can include one more instances of communications circuitry 540 for simultaneously performing several communications operations using different communications networks, although only one is shown in this Figure to avoid overcomplicating the drawing. For example, electronic device 130 can include a first instance of communications circuitry 540 for communicating over a cellular network, and a second instance of communications circuitry 540 for communicating over Wi-Fi or using Bluetooth. In some embodiments, the same instance of communications circuitry 540 can be operative to provide for communications over several communications networks.

In some embodiments, electronic device 130 can be coupled to a host device such as digital content control server 150 for data transfers, synching the communications device, software or firmware updates, providing performance information to a remote source, e.g., providing riding characteristics to a remote server, or performing any other suitable operation that can require electronic device 130 to be coupled to a host device. Several electronic devices 130 can be coupled to a single host device using the host device as a server. Alternatively or additionally, electronic device 130 can be coupled to several host devices, e.g., for each of the plurality of the host devices to serve as a backup for data stored in electronic device 130.

Although the present invention has been described in relation to particular embodiments thereof, many other variations and other uses will be apparent to those skilled in the art. It is preferred, therefore, that the present invention be limited not by the specific disclosure herein, but only by the gist and scope of the disclosure.

What is claimed is:

1. A method for controlling display of content on an electronic device having an input surface, the method comprising:
displaying a first section of the content on a display screen of the electronic device;
displaying a section control on the display screen;
detecting a selection of the section control on the input surface;
in response to the selection of the section control, displaying a listing of additional sections of the content on the display screen and displaying a skimmer strip associated with the listing of additional sections on the display screen;
detecting a gesture on the skimmer strip; and
scrolling the listing of sections in response to the gesture on the skimmer strip.

2. The method of claim 1, wherein the scrolling act further comprises scrolling more of the listing of sections in response to the gesture than would be scrolled by a gesture of similar length directly on the listing.

3. The method of claim 1, further comprising:
detecting a selection of a second section in the listing of sections; and
displaying the second section on the display screen.

4. The method of claim 1, wherein the skimmer strip is a first skimmer strip, the method further comprising:
displaying an article control on the display screen;
detecting a selection of the article control on the input surface;
in response to the selection of the article control, displaying a listing of articles of the first section of content on the display screen and displaying a second skimmer strip associated with the listing of articles on the display screen.

5. The method of claim 4, wherein the gesture is a first gesture, the method further comprising:
detecting a second gesture on the second skimmer strip; and
scrolling the listing of articles in response to the second gesture on the second skimmer strip.

6. The method of claim 4, further comprising:
detecting a selection of a particular article in the listing of articles; and
displaying the particular article on the display screen.

7. The method of claim 4,
wherein the act of displaying the section control further comprises displaying the section control on a bottom edge of the display screen; and
wherein the act of displaying the article control further comprises displaying the article control on a vertical edge of the display screen.

8. The method of claim 4, wherein the article control is a first article control, and wherein the act of displaying the first article control further comprises displaying the first article control on a first vertical edge of the display screen, the method further comprising:
displaying a second article control on a second vertical edge of the display screen, the first vertical edge being opposite the second vertical edge.

9. A system for controlling display of content on an electronic device, the system comprising:
a display screen on which content is displayed;
an input surface for detecting gestures made on the input surface;
a memory that includes the content and instructions for operating the device; and
control circuitry coupled to the memory, coupled to the input surface and coupled to the display screen, the control circuitry capable of executing the instructions and is operable to at least:
display a first section of the content on the display screen;
display a section control on the display screen;
detect a selection of the section control on the input surface;
in response to the selection of the section control, display a listing of additional sections of the content on the display screen and display a skimmer strip associated with the listing of additional sections on the display screen;
detect a gesture on the skimmer strip; and
scroll the listing of sections in response to the gesture on the skimmer strip.

10. The system of claim 9, wherein the scroll of the listing of sections further comprises scrolling more of the listing of sections in response to the gesture than would be scrolled by a gesture of similar length directly on the listing.

11. The system of claim 9, wherein the control circuitry executing the instructions is further operable to at least:
detect a selection of a second section in the listing of sections; and
display the second section on the display screen.

12. The system of claim 9, wherein the skimmer strip is a first skimmer strip and wherein the control circuitry executing the instructions is further operable to at least:
display an article control on the display screen;
detect a selection of the article control on the input surface;
in response to the selection of the article control, display a listing of articles of the first section of content on the display screen and display a second skimmer strip associated with the listing of articles on the display screen.

13. The system of claim 12, wherein the gesture is a first gesture, the control circuitry executing the instructions is further operable to at least:
detect a second gesture on the second skimmer strip; and
scroll the listing of articles in response to the second gesture on the second skimmer strip.

14. The method of claim 12, wherein the control circuitry executing the instructions is further operable to at least:
detect a selection of a particular article in the listing of articles; and
display the particular article on the display screen.

15. The system of claim 12,
wherein the control circuitry is operable to display the section control on a bottom edge of the display screen; and
wherein the control circuitry is operable to display the article control on a vertical edge of the display screen.

16. The system of claim 12, wherein the article control is a first article control, and wherein the first article control is displayed on a first vertical edge of the display screen, the control circuitry executing the instructions is further operable to at least:
display a second article control on a second vertical edge of the display screen, the first vertical edge being opposite the second vertical edge.

17. A non-transitory computer-readable medium comprising a plurality of instructions that, when executed by at least one electronic device, at least cause the at least one electronic device to:
display a first section of the content on a display screen of the electronic device;
display a section control on the display screen;
detect a selection of the section control on an input surface of the electronic device;
in response to the selection of the section control, display a listing of additional sections of the content on the display screen and display a skimmer strip associated with the listing of additional sections on the display screen;
detect a gesture on the skimmer strip; and
scroll the listing of sections in response to the gesture on the skimmer strip.

18. The non-transitory computer-readable medium of claim 17, wherein the instructions further cause the at least one electronic device to scroll more of the listing of sections in response to the gesture than would be scrolled by a gesture of similar length directly on the listing

19. The non-transitory computer-readable medium of claim 17, wherein the skimmer strip is a first skimmer strip and wherein the instructions further cause the at least one electronic device to:
detect a selection of a second section in the listing of sections; and
display the second section on the display screen.

20. The non-transitory computer-readable medium of claim 1, wherein the instructions further cause the at least one electronic device to:
display an article control on the display screen;
detect a selection of the article control on the input surface;
in response to the selection of the article control, display a listing of articles of the first section of content on the display screen and display a second skimmer strip associated with the listing of articles on the display screen.
